(19) United States
(12) Patent Application Publication
(10) Pub. No.: US 2026/0154826 A1
(43) Pub. Date: Jun. 4, 2026

(54) 3D OBJECT TRACKING USING 2D SURROUND-VIEW FEATURE AGGREGATION

(71) Applicant: QUALCOMM Incorporated, San Diego, CA (US)

(72) Inventors: Narayanan Elavathur Ranganatha, San Diego, CA (US); Amin Ansari, Kirkland, WA (US); Sai Madhuraj Jadhav, Foster City, CA (US)

(21) Appl. No.: 18/967,303

(22) Filed: Dec. 3, 2024

(51) Int. Cl. G06T 7/246; G06T 7/73

(52) U.S. Cl. CPC G06T 7/248; G06T 7/74; G06T 2207/10016; G06T 2207/20084

(57) ABSTRACT

Two-dimensional (2D) tracking data from multiple camera views is processed to determine three-dimensional (3D) object parameters. Image features are extracted from object data associated with 2D tracking across the camera views. The extracted features for objects visible in multiple views are aggregated and spatial representation tokens are generated based on the object data and reference vectors. Instead of computing birds-eye-view (BEV) features, 3D spatial parameters can be determined directly from the aggregated features and spatial representation tokens. Attention operations analyze relationships between different feature sets while frame-to-frame consistency is maintained in the determined 3D parameters. Multi-view feature aggregation and spatial token generation operate directly on 2D tracking data from surround-view cameras, allowing feature processing without view-specific geometric transformations. Direct 2D-to-3D transformation supports object tracking across different camera configurations and viewing conditions.

### TECHNICAL FIELD

Aspects of the present disclosure relate generally to image processing, and more particularly, to three-dimensional (3D) object tracking using camera-based surround-view features. Some features enable improved object tracking across multiple camera views, including improved 3D position determination without requiring birds-eye-view (BEV) feature computation.

### BACKGROUND

Traditional multi-object tracking systems that rely on camera-based sensing face several challenges. When performing three-dimensional (3D) object tracking using only camera frames the tracking system may struggle to accurately reason about scene geometry. This can lead to various tracking errors, including missed detections, incorrect object associations, and temporal inconsistencies, particularly in scenarios involving occlusions or irregular object movement.

To address the foregoing challenges, conventional approaches often employ birds-eye-view (BEV) feature computation. In such systems, features extracted from multiple surround-view cameras are projected into a common BEV space before being processed through a decoder. However, while a BEV-based approach enables feature aggregation across different camera views during 3D estimation, it also introduces significant computational overhead. Further, BEV-based systems tend to be sensitive to changes in sensor configuration, which makes them less adaptable across different camera setups.

Two-dimensional (2D) tracking approaches have demonstrated more stable performance and better resilience to changes in camera parameters compared to direct 3D tracking methods. However, existing 2D tracking systems typically process each camera view independently—limiting their ability to utilize information from multiple viewpoints effectively. Also, traditional 2D tracking approaches can result in duplicate detections when objects appear in multiple views and reduced tracking accuracy when objects move between camera views.

Further, current solutions often require extensive computational resources for processing features in 3D space, which often impacts real-time performance in practical applications. There remains a need for improved techniques that can efficiently transform 2D tracking information into accurate 3D object parameters while maintaining robustness across different viewing conditions and camera configurations.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

One innovative aspect of the subject matter described in this disclosure can be implemented in an image processing device. The image processing device includes a memory storing processor-readable code and at least one processor coupled to the memory. The processor is configured to perform two-dimensional (2D) tracking of objects across camera views, extract image features from object data associated with the 2D tracking, aggregate the extracted features for objects visible in multiple views, generate spatial representation tokens based on the object data and reference vectors, and determine three-dimensional (3D) spatial parameters based on the aggregated features and spatial representation tokens. According to aspect, the processor extracts features from regions corresponding to the object data and normalizes them, while transforming the aggregated features into camera-agnostic representations. According to another aspect, cross-attention operations can be performed between the aggregated features and spatial representation tokens, which can be generated through initialization and updating of reference vectors using self-attention operations.

In some examples, features can be extracted from regions corresponding to the object data and normalized. The extracted features for visible objects can be stacked and transformed into camera-agnostic features. The spatial representation tokens can be generated by initializing reference vectors, updating them through self-attention operations, and combining them with spatial information. Different processing applies to objects visible in single views versus multiple views. Position and dimension parameters can be generated while maintaining consistency across frames. The reference vectors comprise learnable embeddings initialized before token generation, and the tokens encode spatial and appearance information through cross-attention operations with the aggregated features.

Another innovative aspect can be implemented in an image processing device that processes object tracking data across camera views. The device receives object tracking data for objects across camera views, normalizes image features extracted from regions associated with the tracking data, combines the normalized features for objects visible in multiple views to a combined feature set, analyzes spatial relationships between the combined feature set and an object token using attention operations, where the object token is associated with the tracking data and reference vectors, and determines 3D parameters based on the analysis. According to an aspect, spatial relationships between the combined features and object tokens can be analyzed using attention operations, with specific correlations identified between spatial information components. According to another aspect, the device initializes and updates reference vectors based on the tracking data while maintaining temporal consistency of the determined 3D parameters across successive frames.

In some examples, the normalized features can be transformed to a standardized format and combined into a unified representation. Spatial correlations can be identified between the combined feature set and object token. The object token is generated by initializing and updating reference vectors based on the tracking data, while maintaining consistency of the 3D parameters across successive frames.

A further innovative aspect can be implemented in an image processing device that manages cross-view object associations. The device identifies overlapping view regions between camera views, analyzes spatial relationships between the overlapping regions, generates view association data for objects detected across the views, determines association costs between object detections, selects optimal object associations based on the costs, and maintains consistency of the associations across successive frames. According to an aspect, view association data is generated incorporating learned detection and tracking information, while association costs can be determined using object region indicators and correspondence metrics. According to another aspect, the device selects optimal associations using Hungarian matching techniques and maintains consistency across frames. Confidence adjustments are made for regions where objects are not visible.

In some examples, optimal matching between object detections can use Hungarian matching techniques. Information sharing operations between regions can employ transformer-based attention mechanisms. Object representations include learned detection and tracking information. Object region indicators are generated and correspondence metrics computed between detected objects and reference objects, with confidence indicators adjusted for regions where objects are not visible.

The foregoing aspects enable efficient processing of multi-view camera data without requiring intermediate geometric transformations. And associated processing architecture supports flexible deployment across various camera configurations while maintaining consistent object tracking performance.

Methods of image processing described herein may be performed by an image capture device and/or performed on image data captured by one or more image capture devices. Image capture devices, devices that can capture one or more digital images, whether still image photos or sequences of images for videos, can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, or other devices with digital imaging or video capabilities.

The image processing techniques described herein may involve digital cameras having image sensors and processing circuitry (e.g., application specific integrated circuits (ASICs), digital signal processors (DSP), graphics processing unit (GPU), or central processing units (CPU)). An image signal processor (ISP) may include one or more of these processing circuits and configured to perform operations to obtain the image data for processing according to the image processing techniques described herein and/or involved in the image processing techniques described herein. The ISP may be configured to control the capture of image frames from one or more image sensors and determine one or more image frames from the one or more image sensors to generate a view of a scene in an output image frame. The output image frame may be part of a sequence of image frames forming a video sequence. The video sequence may include other image frames received from the image sensor or other images sensors.

In an example application, the image signal processor (ISP) may receive an instruction to capture a sequence of image frames in response to the loading of software, such as a camera application, to produce a preview display from the image capture device. The image signal processor may be configured to produce a single flow of output image frames, based on images frames received from one or more image sensors. The single flow of output image frames may include raw image data from an image sensor, binned image data from an image sensor, or corrected image data processed by one or more algorithms within the image signal processor. For example, an image frame obtained from an image sensor, which may have performed some processing on the data before output to the image signal processor, may be processed in the image signal processor by processing the image frame through an image post-processing engine (IPE) and/or other image processing circuitry for performing one or more of tone mapping, portrait lighting, contrast enhancement, gamma correction, etc. The output image frame from the ISP may be stored in memory and retrieved by an application processor executing the camera application, which may perform further processing on the output image frame to adjust an appearance of the output image frame and reproduce the output image frame on a display for view by the user.

After an output image frame representing the scene is determined by the image signal processor and/or determined by the application processor, such as through image processing techniques described in various embodiments herein, the output image frame may be displayed on a device display as a single still image and/or as part of a video sequence, saved to a storage device as a picture or a video sequence, transmitted over a network, and/or printed to an output medium. For example, the image signal processor (ISP) may be configured to obtain input frames of image data (e.g., pixel values) from the one or more image sensors, and in turn, produce corresponding output image frames (e.g., preview display frames, still-image captures, frames for video, frames for object tracking, etc.). In other examples, the image signal processor may output image frames to various output devices and/or camera modules for further processing, such as for 3A parameter synchronization (e.g., automatic focus (AF), automatic white balance (AWB), and automatic exposure control (AEC)), producing a video file via the output frames, configuring frames for display, configuring frames for storage, transmitting the frames through a network connection, etc. Generally, the image signal processor (ISP) may obtain incoming frames from one or more image sensors and produce and output a flow of output frames to various output destinations.

In some aspects, the output image frame may be produced by combining aspects of the image correction of this disclosure with other computational photography techniques such as high dynamic range (HDR) photography or multi-frame noise reduction (MFNR). With HDR photography, a first image frame and a second image frame are captured using different exposure times, different apertures, different lenses, and/or other characteristics that may result in improved dynamic range of a fused image when the two image frames are combined. In some aspects, the method may be performed for MFNR photography in which the first image frame and a second image frame are captured using the same or different exposure times and fused to generate a corrected first image frame with reduced noise compared to the captured first image frame.

In some aspects, a device may include an image signal processor or a processor (e.g., an application processor) including specific functionality for camera controls and/or processing, such as enabling or disabling the binning module or otherwise controlling aspects of the image correction. The methods and techniques described herein may be entirely performed by the image signal processor or a processor, or various operations may be split between the image signal processor and a processor, and in some aspects split across additional processors.

The device may include one, two, or more image sensors, such as a first image sensor. When multiple image sensors are present, the image sensors may be differently configured. For example, the first image sensor may have a larger field of view (FOV) than the second image sensor, or the first image sensor may have different sensitivity or different dynamic range than the second image sensor. In one example, the first image sensor may be a wide-angle image sensor, and the second image sensor may be a tele image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. Any of these or other configurations may be part of a lens cluster on a mobile device, such as where multiple image sensors and associated lenses are located in offset locations on a frontside or a backside of the mobile device. Additional image sensors may be included with larger, smaller, or same fields of view. The image processing techniques described herein may be applied to image frames captured from any of the image sensors in a multi-sensor device.

In an additional aspect of the disclosure, a device configured for image processing and/or image capture is disclosed. The apparatus includes means for capturing image frames. The apparatus further includes one or more means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors) and time of flight detectors. The apparatus may further include one or more means for accumulating and/or focusing light rays into the one or more image sensors (including simple lenses, compound lenses, spherical lenses, and non-spherical lenses). These components may be controlled to capture the first and/or second image frames input to the image processing techniques described herein.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

The method may be embedded in a computer-readable medium as computer program code comprising instructions that cause a processor to perform the steps of the method. In some embodiments, the processor may be part of a mobile device including a first network adaptor configured to transmit data, such as images or videos in a recording or as streaming data, over a first network connection of a plurality of network connections; and a processor coupled to the first network adaptor and the memory. The processor may cause the transmission of output image frames described herein over a wireless communications network such as a 5G NR communication network.

The foregoing has outlined, rather broadly, the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows a block diagram of an example device for performing image capture and processing from multiple surround-view cameras.

FIG. 2 is a block diagram illustrating an example data flow path for image data processing in an image capture device according to some embodiments of the disclosure.

FIG. 3 shows a flow chart of an example method for processing image data to perform three-dimensional (3D) object tracking using two-dimensional (2D) surround-view features according to some embodiments of the disclosure.

FIG. 4 is a block diagram illustrating an example processor configuration implementing the 2D-to-3D tracking method of FIG. 3 in an image capture device according to some embodiments of the disclosure.

FIG. 5 shows a flow chart of an example method for processing image data to perform 3D object tracking based on normalized image features and spatial relationship analysis according to some embodiments of the disclosure.

FIG. 6 is a block diagram illustrating an example processor configuration implementing the feature normalization and spatial analysis method of FIG. 5 in an image capture device according to some embodiments of the disclosure.

FIG. 7 shows a flow chart of an example method for processing image data to perform cross-view object association and temporal consistency maintenance according to some embodiments of the disclosure.

FIG. 8 is a block diagram illustrating an example processor configuration implementing the cross-view association method of FIG. 7 in an image capture device according to some embodiments of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support image processing, including techniques for three-dimensional (3D) object tracking using two-dimensional (2D) surround-view camera data. Disclosed techniques encompass feature extraction and aggregation across multiple camera views, spatial token generation for object representation, and cross-view object association without requiring birds-eye-view (BEV) feature computation.

Existing approaches to 3D object tracking using camera-based systems often rely on complex geometric transformations of features into BEV space before determining object parameters. Such approaches typically require substantial computational resources and exhibit sensitivity to specific camera configurations. Additionally, current systems may struggle with occlusions, irregular object movement, and temporal consistency maintenance. Shortcomings mentioned here are only representative and are included to highlight problems that the inventors have identified with respect to existing devices and sought to improve upon. Aspects of devices described below may address some or all of the shortcomings as well as others known in the art. Aspects of the improved devices described herein may present other benefits than, and be used in other applications than, those described above.

In a first aspect, a processing device performs 2D tracking across multiple camera views and extracts image features from regions corresponding to tracked objects. The device aggregates these features for objects visible in multiple views, generating normalized, camera-agnostic representations. Rather than transforming features into BEV space, the device generates spatial representation tokens by combining object data with learnable reference vectors. Through analysis of relationships between the aggregated features and these tokens, the system determines 3D spatial parameters while maintaining consistency across successive frames.

A second aspect focuses on feature processing and normalization. After receiving object tracking data, the system extracts and normalizes image features from regions associated with tracked objects. These features undergo standardized format transformation before being combined into a unified representation for objects visible across multiple views. The system also analyzes spatial relationships between combined feature sets and object tokens through attention operations to enable direct determination of 3D parameters without intermediate geometric transformations.

A third aspect addresses cross-view object association. The system identifies overlapping regions between camera views and analyzes spatial relationships within the overlapping regions. View association data is generated using learned detection and tracking information with association costs computed between object detections in different views. Through techniques derived from, e.g., Hungarian matching algorithms, the system determines optimal object associations while maintaining temporal consistency. This framework handles instances where objects become temporarily occluded or appear only in subset of camera views.

Particular implementations of the subject matter described in this disclosure may be implemented to realize one or more of the following potential advantages or benefits. In some aspects, the present disclosure provides techniques for efficient 3D object tracking that eliminate intermediate geometric transformations. Direct processing of 2D tracking data substantially reduces computational overhead compared to systems requiring BEV feature computation. Memory requirements decrease significantly as features remain in their original 2D space rather than being projected into a common 3D coordinate system.

The system's feature aggregation framework, coupled with spatial token generation, enables robust parameter determination across varying camera setups. Processing features in their native 2D space provides inherent resilience to camera parameter variations. Such an architecture allows deployment across different vehicle platforms without requiring extensive recalibration or modification of the underlying processing pipeline.

By analyzing overlapping view regions and generating targeted association data, the system maintains accurate object tracking even under challenging conditions. When objects become occluded in certain views, information from remaining viewpoints preserves tracking continuity. The selective processing of features-applying different operations for single-view versus multi-view objects-optimizes computational resource utilization while maintaining tracking accuracy across the full field of view.

Normalizing features into standardized formats, when combined with unified representation generation, ensures consistent processing regardless of object scale or appearance variations. Also, learned reference patterns adapt automatically to different object characteristics and viewing conditions. This adaptive framework, augmented by temporal consistency maintenance, yields stable tracking output even during irregular object movement or partial occlusions.

Further, implementing transformer-based attention mechanisms within overlapping view regions enables efficient information sharing between cameras. Here, the system's ability to adjust confidence indicators for non-visible regions, while maintaining object identity through learned embeddings, supports reliable tracking across frame boundaries. Such capabilities emerge from the underlying architecture rather than requiring additional computational layers or post-processing steps.

Implementations described herein address known challenges in object tracking by using an architecture that performs three-dimensional (3D) object tracking using two-dimensional (2D) surround-view feature aggregation without requiring birds-eye-view (BEV) feature computation. Initially, 2D tracking is performed across multiple surround-view cameras while associating objects visible in multiple views with consistent identifiers. This 2D surround-view tracking provides a foundation for information flow between different camera perspectives and enables the system to maintain object tracking even when an object becomes temporarily occluded in one viewpoint. The 2D surround-view tracking provides feature aggregation across views that avoids computational overhead of BEV feature generation. For instance, rather than projecting features into a common BEV space, objects are associated across views explicitly to allow for targeted aggregation of features corresponding to tracked objects. Doing so eliminates the need to process non-relevant features such as, e.g., those belonging to background elements.

Implementations extend existing tracking models to accommodate multi-view input and output by using different components. For example, cross-view transformers facilitate information sharing between camera perspectives, operating on maximal overlap regions identified between views up to a configurable distance threshold (e.g., 150 meters). To ensure consistency across views, implementations can employ shared detect-and-track queries for all cameras. Also, object association across views can be handled through, e.g., multi-view Hungarian matching techniques that associate box predictions with ground truth data. It should be appreciated that the foregoing approach does not require explicit 3D labels during training. Rather, the system can be trained using datasets containing only 2D tracking labels while still enabling accurate 3D parameter estimation. When 3D tracking datasets are available they can be leveraged by projecting 3D boxes onto the image plane to generate corresponding 2D training labels.

According to one implementation, the processing pipeline operates as follows. For each frame, image features are extracted from the surround-view camera inputs {It(0), It(1), . . . , It(5)} using a shared encoder network to produce feature maps {F(0), F(1), . . . , F(5)}. These feature maps undergo cross-view attention operations within the identified overlap regions between cameras. The resulting aggregated features {F_{agg}(0), F_{agg}(1), . . . , F_{agg}(5)} are then processed using a shared query individual view tracking module that maintains temporal consistency while handling cross-view associations. The tracking module can use two types of queries: (1) proposal queries for detecting new objects, and (2) track queries for maintaining existing tracks. The queries interact with the aggregated features through self-attention and cross-attention mechanisms. Box predictions {B(0), B(1), . . . , B(5)} are generated for each camera view and subsequently associated across views using multi-view Hungarian matching against the ground truth data.

For each object visible in multiple views, feature patches are extracted from the corresponding regions in the aggregated feature maps using ROIAlign operations. The patches, which typically have higher channel dimensionality than the input images, are normalized to a fixed size suitable for neural network processing. The normalized patches are then stacked and passed through a multilayer perceptron (MLP) to generate a unified feature representation. Also, objects visible in only a single view undergo modified processing—their feature maps may be duplicated and passed through the same MLP to ensure consistent feature space mapping, or alternatively, may follow a separate processing path that bypasses the MLP to reduce computational overhead for single-view cases.

A box token can be generated for each tracked object by combining a learnable query vector with the associated 2D bounding boxes. The box token undergoes multiple iterations of deformable cross-attention operations with the unified image features, thereby enabling the system to learn complex functional approximations for deriving 3D parameters from 2D tracking data. The cross-attention mechanisms can be implemented through a combination of reference point generation, offset computation, and key-value pair generation. These operations can be performed iteratively, with self-attention blocks refining the box token representations while cross-attention blocks integrate spatial and appearance information from the image features.

Such implementations offer advantages over traditional BEV-based methods, including reduced computational complexity, improved robustness to camera configuration changes, efficient handling of occlusions and view transitions, flexible deployment across different sensor setups without requiring extensive recalibration, and an ability to leverage both 2D-only and 3D datasets during training. Further, implementations maintain temporal consistency through continuous monitoring and adjustment processes that update reference vectors based on new object data while preserving stable object identities across view transitions. And, consistency checks can be performed to ensure reliable tracking across frame boundaries.

Further, cross-view association costs can be computed using multiple geometric and appearance factors, with learned metrics contributing to robust matching across different viewing conditions. Confidence indicators can be modified or updated when objects become temporarily non-visible in certain views, which provides stable tracking performance without requiring complex geometric transformations or intermediate processing steps. Considering the foregoing, implementations can achieve efficient 3D object tracking while maintaining robustness across varying camera configurations and viewing conditions. It follows that implementations can accommodate flexible deployment across platforms while providing consistent tracking performance through direct processing of 2D surround-view features.

In the description of embodiments herein, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

An example device for capturing image frames using one or more image sensors, such as a smartphone, may include a configuration of one, two, three, four, or more camera modules on a backside (e.g., a side opposite a primary user display) and/or a front side (e.g., a same side as a primary user display) of the device. The devices may include one or more image signal processors (ISPs), Computer Vision Processors (CVPs) (e.g., AI engines), or other suitable circuitry for processing images captured by the image sensors. The one or more image signal processors (ISP) may store output image frames (such as through a bus) in a memory and/or provide the output image frames to processing circuitry (such as an applications processor). The processing circuitry may perform further processing, such as for encoding, storage, transmission, or other manipulation of the output image frames.

As used herein, a camera module may include the image sensor and certain other components coupled to the image sensor used to obtain a representation of a scene in image data comprising an image frame. For example, a camera module may include other components of a camera, including a shutter, buffer, or other readout circuitry for accessing individual pixels of an image sensor. In some embodiments, the camera module may include one or more components including the image sensor included in a single package with an interface configured to couple the camera module to an image signal processor or other processor through a bus.

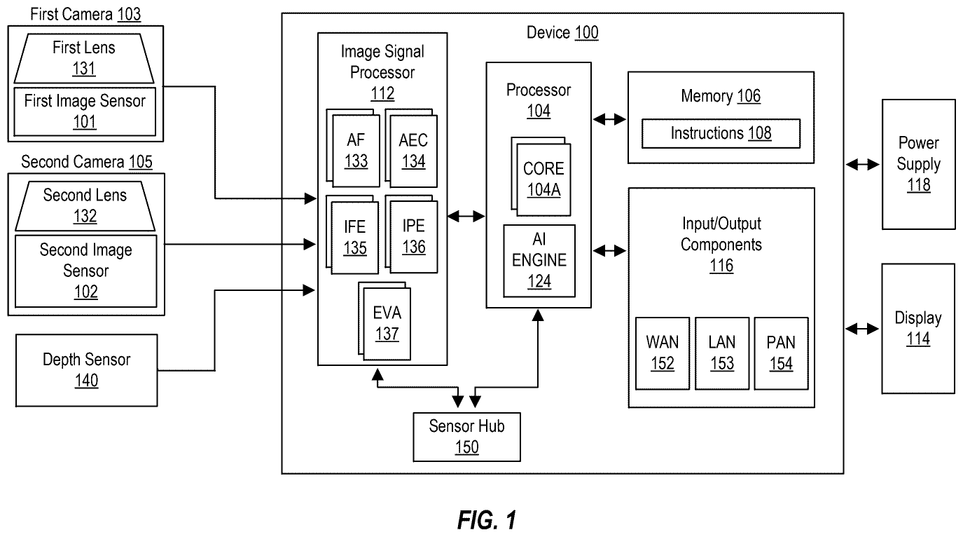

FIG. 1 shows a block diagram of a device 100 for performing image capture from one or more image sensors. The device 100 may include, or otherwise be coupled to, an image signal processor (e.g., ISP 112) for processing image frames from one or more image sensors, such as a first image sensor 101, a second image sensor 102, and a depth sensor 140. In some implementations, the device 100 also includes or is coupled to a processor 104 and a memory 106 storing instructions 108 (e.g., a memory storing processor-readable code or a non-transitory computer-readable medium storing instructions). The device 100 may also include or be coupled to a display 114 and components 116. Components 116 may be used for interacting with a user, such as a touch screen interface and/or physical buttons.

Components 116 may also include network interfaces for communicating with other devices, including a wide area network (WAN) adaptor (e.g., WAN adaptor 152), a local area network (LAN) adaptor (e.g., LAN adaptor 153), and/or a personal area network (PAN) adaptor (e.g., PAN adaptor 154). A WAN adaptor 152 may be a 4G LTE or a 5G NR wireless network adaptor. A LAN adaptor 153 may be an IEEE 802.11 WiFi wireless network adapter. A PAN adaptor 154 may be a Bluetooth wireless network adaptor. Each of the WAN adaptor 152, LAN adaptor 153, and/or PAN adaptor 154 may be coupled to an antenna, including multiple antennas configured for primary and diversity reception and/or configured for receiving specific frequency bands. In some embodiments, antennas may be shared for communicating on different networks by the WAN adaptor 152, LAN adaptor 153, and/or PAN adaptor 154. In some embodiments, the WAN adaptor 152, LAN adaptor 153, and/or PAN adaptor 154 may share circuitry and/or be packaged together, such as when the LAN adaptor 153 and the PAN adaptor 154 are packaged as a single integrated circuit (IC).

The device 100 may further include or be coupled to a power supply 118 for the device 100, such as a battery or an adaptor to couple the device 100 to an energy source. The device 100 may also include or be coupled to additional features or components that are not shown in FIG. 1. In one example, a wireless interface, which may include a number of transceivers and a baseband processor in a radio frequency front end (RFFE), may be coupled to or included in WAN adaptor 152 for a wireless communication device. In a further example, an analog front end (AFE) to convert analog image data to digital image data may be coupled between the first image sensor 101 or second image sensor 102 and processing circuitry in the device 100. In some embodiments, AFEs may be embedded in the ISP 112.

The device may include or be coupled to a sensor hub 150 for interfacing with sensors to receive data regarding movement of the device 100, data regarding an environment around the device 100, and/or other non-camera sensor data. One example non-camera sensor is a gyroscope, which is a device configured for measuring rotation, orientation, and/or angular velocity to generate motion data. Another example non-camera sensor is an accelerometer, which is a device configured for measuring acceleration, which may also be used to determine velocity and distance traveled by appropriately integrating the measured acceleration. In some aspects, a gyroscope in an electronic image stabilization system (EIS) may be coupled to the sensor hub. In another example, a non-camera sensor may be a global positioning system (GPS) receiver, which is a device for processing satellite signals, such as through triangulation and other techniques, to determine a location of the device 100. The location may be tracked over time to determine additional motion information, such as velocity and acceleration. The data from one or more sensors may be accumulated as motion data by the sensor hub 150. One or more of the acceleration, velocity, and/or distance may be included in motion data provided by the sensor hub 150 to other components of the device 100, including the ISP 112 and/or the processor 104.

The ISP 112 may receive captured image data. In one embodiment, a local bus connection couples the ISP 112 to the first image sensor 101 and second image sensor 102 of a first camera 103 and second camera 105, respectively. In another embodiment, a wire interface couples the ISP 112 to an external image sensor. In a further embodiment, a wireless interface couples the ISP 112 to the first image sensor 101 or second image sensor 102.

The first image sensor 101 and the second image sensor 102 are configured to capture image data representing a scene in the field of view of the first camera 103 and second camera 105, respectively. In some embodiments, the first camera 103 and/or second camera 105 output analog data, which is converted by an analog front end (AFE) and/or an analog-to-digital converter (ADC) in the device 100 or embedded in the ISP 112. In some embodiments, the first camera 103 and/or second camera 105 output digital data. The digital image data may be formatted as one or more image frames, whether received from the first camera 103 and/or second camera 105 or converted from analog data received from the first camera 103 and/or second camera 105.

The first camera 103 may include the first image sensor 101 and a first lens 131. The second camera may include the second image sensor 102 and a second lens 132. Each of the first lens 131 and the second lens 132 may be controlled by an associated autofocus (AF) algorithm (e.g., AF 133) executing in the ISP 112, which adjusts the first lens 131 and the second lens 132 to focus on a particular focal plane located at a certain scene depth. The AF 133 may be assisted by depth data received from depth sensor 140. The first lens 131 and the second lens 132 focus light at the first image sensor 101 and second image sensor 102, respectively, through one or more apertures for receiving light, one or more shutters for blocking light when outside an exposure window, and/or one or more color filter arrays (CFAs) for filtering light outside of specific frequency ranges. The first lens 131 and second lens 132 may have different fields of view (FOVs) to capture different representations of a scene. For example, the first lens 131 may be an ultra-wide (UW) lens and the second lens 132 may be a wide (W) lens. The multiple image sensors may include a combination of UW, W, tele (T), and ultra-tele (UT) sensors.

Each of the first camera 103 and second camera 105 may be configured through hardware configuration and/or software settings to obtain different, but overlapping, FOVs. In some configurations, the cameras are configured with different lenses with different magnification ratios that result in different fields of view for capturing different representations of the scene. The cameras may be configured such that a UW camera has a larger FOV than a W camera, which has a larger FOV than a T camera, which has a larger FOV than a UT camera. For example, a camera configured for wide FOV may capture fields of view in the range of 64-84 degrees, a camera configured for ultra-side FOV may capture fields of view in the range of 100-140 degrees, a camera configured for tele FOV may capture fields of view in the range of 10-30 degrees, and a camera configured for ultra-tele FOV may capture fields of view in the range of 1-8 degrees.

In some embodiments, one or more of the first camera 103 and/or second camera 105 may be a variable aperture (VA) camera in which the aperture can be adjusted to set a particular aperture size. Example aperture sizes include f/2.0, f/2.8, f/3.2, f/8.0, etc. Larger aperture values correspond to smaller aperture sizes, and smaller aperture values correspond to larger aperture sizes. A variable aperture (VA) camera may have different characteristics that produced different representations of a scene based on a current aperture size. For example, a VA camera may capture image data with a depth of focus (DOF) corresponding to a current aperture size set for the VA camera.

The ISP 112 processes image frames captured by the first camera 103 and second camera 105. While FIG. 1 illustrates the device 100 as including first camera 103 and second camera 105, any number (e.g., one, two, three, four, five, six, etc.) of cameras may be coupled to the ISP 112. In some aspects, depth sensors such as depth sensor 140 may be coupled to the ISP 112. Output from the depth sensor 140 may be processed in a similar manner to that of first camera 103 and second camera 105. Examples of depth sensor 140 include active sensors, including one or more of indirect Time of Flight (iToF), direct Time of Flight (dToF), light detection and ranging (Lidar), mmWave, radio detection and ranging (Radar), and/or hybrid depth sensors, such as structured light sensors. In embodiments without a depth sensor 140, similar information regarding depth of objects or a depth map may be determined from the disparity between first camera 103 and second camera 105, such as by using a depth-from-disparity algorithm, a depth-from-stereo algorithm, phase detection auto-focus (PDAF) sensors, or the like. In addition, any number of additional image sensors or image signal processors may exist for the device 100.

In some embodiments, the ISP 112 may execute instructions from a memory, such as instructions 108 from the memory 106, instructions stored in a separate memory coupled to or included in the ISP 112, or instructions provided by the processor 104. In addition, or in the alternative, the ISP 112 may include specific hardware (such as one or more integrated circuits (ICs)) configured to perform one or more operations described in the present disclosure. For example, the ISP 112 may include image front ends (e.g., IFE 135), image post-processing engines (e.g., IPE 136), auto exposure compensation (AEC) engines (e.g., AEC 134), and/or one or more engines for video analytics (e.g., EVA 137). An image pipeline may be formed by a sequence of one or more of the IFE 135, IPE 136, and/or EVA 137. In some embodiments, the image pipeline may be reconfigurable in the ISP 112 by changing connections between the IFE 135, IPE 136, and/or EVA 137. The AF 133, AEC 134, IFE 135, IPE 136, and EVA 137 may each include application-specific circuitry, be embodied as software or firmware executed by the ISP 112, and/or a combination of hardware and software or firmware executing on the ISP 112.

The memory 106 may include a non-transient or non-transitory computer readable medium storing computer-executable instructions as instructions 108 to perform all or a portion of one or more operations described in this disclosure. The instructions 108 may include a camera application (or other suitable application such as a messaging application) to be executed by the device 100 for photography or videography. The instructions 108 may also include other applications or programs executed by the device 100, such as an operating system and applications other than for image or video generation. Execution of the camera application, such as by the processor 104, may cause the device 100 to record images using the first camera 103 and/or second camera 105 and the ISP 112.

In addition to instructions 108, the memory 106 may also store image frames. The image frames may be output image frames stored by the ISP 112. The output image frames may be accessed by the processor 104 for further operations. In some embodiments, the device 100 does not include the memory 106. For example, the device 100 may be a circuit including the ISP 112, and the memory may be outside the device 100. The device 100 may be coupled to an external memory and configured to access the memory for writing output image frames for display or long-term storage. In some embodiments, the device 100 is a system-on-chip (SoC) that incorporates the ISP 112, the processor 104, the sensor hub 150, the memory 106, and/or components 116 into a single package.

In some embodiments, at least one of the ISP 112 or the processor 104 executes instructions to perform various operations described herein, including two-dimensional (2D) tracking across multiple camera views, feature extraction and aggregation, spatial token generation, and three-dimensional (3D) parameter determination. For example, execution of the instructions can instruct the ISP 112 to begin or end capturing image frames or sequences of image frames from multiple surround-view cameras, in which the capture includes feature processing and object tracking as described in embodiments herein. In some embodiments, the processor 104 may include one or more general-purpose processor cores 104A-N capable of executing instructions to control operation of the ISP 112. For example, the cores 104A-N may execute a camera application (or other suitable application for generating images or video) stored in the memory 106 that activate or deactivate the ISP 112 for capturing image frames and/or control the ISP 112 in the application of feature extraction, aggregation, and cross-view object association to the image frames. The operations of the cores 104A-N and ISP 112 may be based on user input. For example, a camera application executing on processor 104 may receive a user command to begin a video preview display upon which video comprising sequences of image frames is captured and processed from multiple surround-view cameras through the ISP 112 for display and/or storage. Image processing to determine object tracking outputs, such as according to techniques described herein, may be applied to one or more image frames in the sequence, including feature normalization, spatial token generation, and 3D parameter determination across multiple views.

In some embodiments, the processor 104 may include ICs or other hardware (e.g., an artificial intelligence (AI) engine such as AI engine 124 or other co-processor) to offload certain tasks from the cores 104A-N. The AI engine 124 may be used to offload tasks related to, for example, face detection and/or object recognition performed using machine learning (ML) or artificial intelligence (AI). The AI engine 124 may be referred to as an Artificial Intelligence Processing Unit (AI PU). The AI engine 124 may include hardware configured to perform and accelerate convolution operations involved in executing machine learning algorithms, such as by executing predictive models such as artificial neural networks (ANNs) (including multilayer feedforward neural networks (MLFFNN), the recurrent neural networks (RNN), and/or the radial basis functions (RBF)). The ANN executed by the AI engine 124 may access predefined training weights for performing operations on user data. The ANN may alternatively be trained during operation of the image capture device 100, such as through reinforcement training, supervised training, and/or unsupervised training. In some other embodiments, the device 100 does not include the processor 104, such as when all of the described functionality is configured in the ISP 112.

In some embodiments, the display 114 may include one or more suitable displays or screens allowing for user interaction and/or to present items to the user, such as a preview of the output of the first camera 103 and/or second camera 105. In some embodiments, the display 114 is a touch-sensitive display. The input/output (I/O) components, such as components 116, may be or include any suitable mechanism, interface, or device to receive input (such as commands) from the user and to provide output to the user through the display 114. For example, the components 116 may include (but are not limited to) a graphical user interface (GUI), a keyboard, a mouse, a microphone, speakers, a squeezable bezel, one or more buttons (such as a power button), a slider, a toggle, or a switch.

While shown to be coupled to each other via the processor 104, components (such as the processor 104, the memory 106, the ISP 112, the display 114, and the components 116) may be coupled to each another in other various arrangements, such as via one or more local buses, which are not shown for simplicity. One example of a bus for interconnecting the components is a peripheral component interface (PCI) express (PCIe) bus.

While the ISP 112 is illustrated as separate from the processor 104, the ISP 112 may be a core of a processor 104 that is an application processor unit (APU), included in a system on chip (SoC), or otherwise included with the processor 104. While the device 100 is referred to in the examples herein for performing aspects of the present disclosure, some device components may not be shown in FIG. 1 to prevent obscuring aspects of the present disclosure. Additionally, other components, numbers of components, or combinations of components may be included in a suitable device for performing aspects of the present disclosure. As such, the present disclosure is not limited to a specific device or configuration of components, including the device 100.

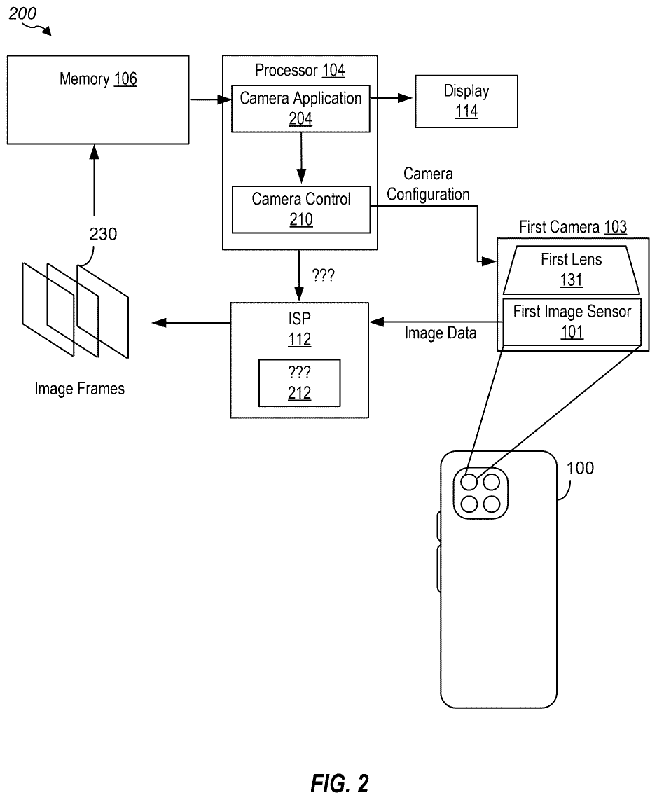

FIG. 2 is a block diagram illustrating an example data flow path for image data processing in an image capture device according to one or more embodiments of the disclosures. Processor 104 of system 200 may communicate with ISP 112 through a bi-directional bus and/or separate control and data lines. The processor 104 may control the first camera 103 through camera control 210. The camera control 210 may be a camera driver executed by the processor 104 for configuring the first camera 103, such as to active or deactivate image capture, configure exposure settings, and/or configure aperture size. Camera control 210 may be managed by a camera application 204 executing on the processor 104. The camera application 204 provides settings accessible to a user such that a user can specify individual camera settings or select a profile with corresponding camera settings. Camera control 210 communicates with the first camera 103 to configure the first camera 103 in accordance with commands received from the camera application 204. The camera application 204 may be, for example, a photography application, a document scanning application, a messaging application, or other application that processes image data acquired from the first camera 103.

The camera configuration may include parameters that specify, for example, a frame rate, an image resolution, a readout duration, an exposure level, an aspect ratio, an aperture size, etc. The first camera 103 may apply the camera configuration and obtain image data representing a scene using the camera configuration. In some embodiments, the camera configuration may be adjusted to obtain different representations of the scene. For example, the processor 104 may execute a camera application 204 to instruct the first camera 103, through camera control 210, to set a first camera configuration for the first camera 103, to obtain first image data from the first camera 103 operating in the first camera configuration, to instruct the first camera 103 to set a second camera configuration for the first camera 103, and to obtain second image data from the first camera 103 operating in the second camera configuration.

In some embodiments in which the first camera 103 is a variable aperture (VA) camera system, the processor 104 may execute a camera application 204 to instruct the first camera 103 to configure to a first aperture size, obtain first image data from the first camera 103, instruct the first camera 103 to configure to a second aperture size, and obtain second image data from the first camera 103. The reconfiguration of the aperture and obtaining of the first and second image data may occur with little or no change in the scene captured at the first aperture size and the second aperture size. Example aperture sizes are f/2.0, f/2.8, f/3.2, f/8.0, etc. Larger aperture values correspond to smaller aperture sizes, and smaller aperture values correspond to larger aperture sizes. That is, f/2.0 corresponds to a larger aperture size than f/8.0.

The image data received from the first camera 103 may be processed in one or more blocks of the ISP 112 to determine output image frames 230 that may be stored in memory 106 and/or otherwise provided to the processor 104. The processor 104 may further process the image data to apply effects to the output image frames 230. Effects may include Bokeh, lighting, color casting, and/or high dynamic range (HDR) merging. In some embodiments, the effects may be applied in the ISP 112.

The output image frames 230 by the ISP 112 may include representations of the scene improved by aspects of this disclosure, such that 3D object parameters are determined directly from 2D tracking data across multiple camera views without requiring birds-eye-view (BEV) feature computation. The processor 104 may display these output image frames 230 to a user, and the improvements provided by the described processing implemented in the ISP 112 and/or processor 104 improve the tracking quality and the user experience by maintaining consistent object tracking across different viewing conditions and camera configurations. For example, feature extraction and aggregation in the ISP 112 may involve processing the image data received from multiple surround-view cameras when determining the output image frames 230, including normalizing extracted features, generating spatial representation tokens, and performing cross-view object association. A tracking consistency maintenance module in the ISP 112 ensures temporal coherence of object tracking across successive frames while handling occlusions and varying object visibility across different camera views.

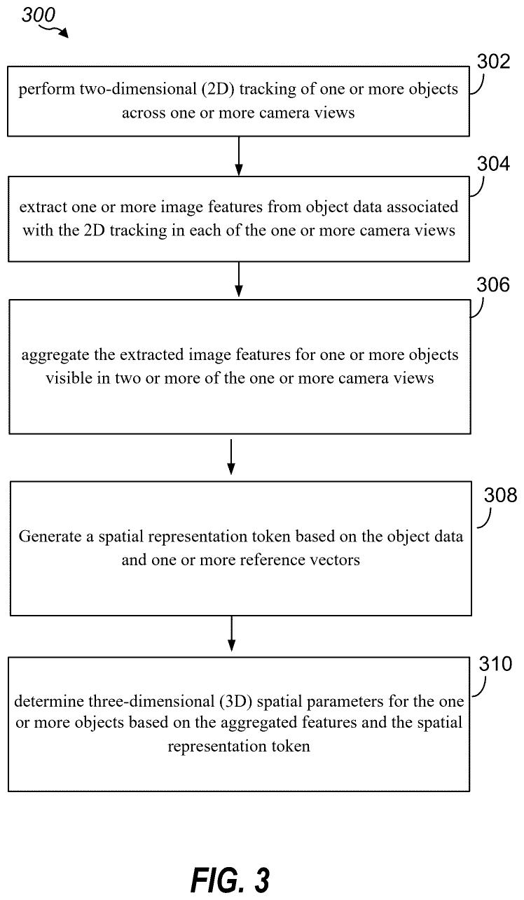

FIG. 3 shows a flow chart of an example method 300 for processing image data to perform three-dimensional (3D) object tracking using two-dimensional (2D) surround-view features according to some embodiments of the disclosure. The processing in FIG. 3 obtains 3D object parameters directly from 2D tracking data, which enables efficient object tracking across multiple camera views without requiring birds-eye-view (BEV) feature computation. Each of the operations described with reference to FIG. 3 may be performed by one or a combination of the processor 104 (including cores 104A-N or AI engine 124) and/or the ISP 112. Further, the system 200 of FIG. 2 may be configured to perform the operations described with reference to FIG. 3.

At block 302, the system performs two-dimensional (2D) tracking of one or more objects across one or more camera views. The tracking data may be received from multiple surround-view cameras, such as the first camera 103 or from image data stored in memory 106. In some implementations, the capture of image data may be initiated by a camera application executing on processor 104, which causes camera control 210 to coordinate capture and processing of image data from multiple cameras. The tracking data may alternatively be received from a wireless camera through one or more of the WAN adaptor 152, the LAN adaptor 153, and/or the PAN adaptor 154, or retrieved from a memory location or network storage location.

At block 304, the system extracts one or more image features from object data associated with the 2D tracking in each of the one or more camera views. The ISP 112 processes image data from each camera to identify and extract relevant features. In some implementations, the system extracts features from regions corresponding to the object data and normalizes these features. Feature extraction may involve analyzing regions corresponding to tracked object data and generating camera-agnostic representations. The extracted features may undergo different processing depending on whether objects are visible in single or multiple views.

At block 306, the system aggregates the extracted image features for one or more objects visible in two or more of the one or more camera views. This aggregation includes stacking the extracted image features and generating camera-agnostic features. The processor 104 or ISP 112 may combine features from different views while maintaining spatial relationships between the detected objects. The system may differentiate the extracted image features for objects visible in only one camera view compared to objects visible in multiple views.

At block 308, the system generates a spatial representation token based on the object data and one or more reference vectors. This generation includes initializing a set of reference vectors, updating them using self-attention operations, and combining the updated reference vectors with spatial information from the object data. The reference vectors can comprise learnable embeddings initialized prior to token generation. The spatial representation token can encode spatial or appearance information through cross-attention operations with the aggregated features.

At block 310, the system determines three-dimensional (3D) spatial parameters for the one or more objects based on the aggregated features and the spatial representation token. This determination can include performing cross-attention operations between the aggregated features and the spatial representation token. The system generates position and dimension parameters for each object while maintaining consistency of these parameters across successive frames.

The method 300 supports various implementation scenarios based on different camera configurations and processing requirements. The processing pipeline adapts to different camera setups while maintaining consistent tracking performance across varying viewing conditions. In some implementations following the feature aggregation at block 306, the system implements different processing paths based on visibility patterns. The system routes single-view objects through a streamlined processing path while directing multi-view objects through additional feature fusion steps to maximize information utilization from all available viewpoints.

After determining 3D parameters at block 310, the system can maintain temporal consistency through continuous monitoring and adjustment processes. The system updates reference vectors based on new object data and preserves stable object identities as objects move between different camera views. Specific consistency checks ensure reliable tracking across frame boundaries. For complex tracking scenarios, the system employs additional view association techniques after the main processing steps. The system analyzes spatial relationships within overlapping camera view regions and generates association data using learned detection and tracking information. Computing association costs between object detections across different views enables the system to maintain consistent object tracking during view transitions or partial occlusions.

The system adapts processing parameters based on specific implementation requirements and camera configurations. When objects become temporarily non-visible in certain views, the system adjusts confidence indicators accordingly. This adaptive framework enables tracking performance across varying camera setups without requiring complex geometric transformations or intermediate processing steps.

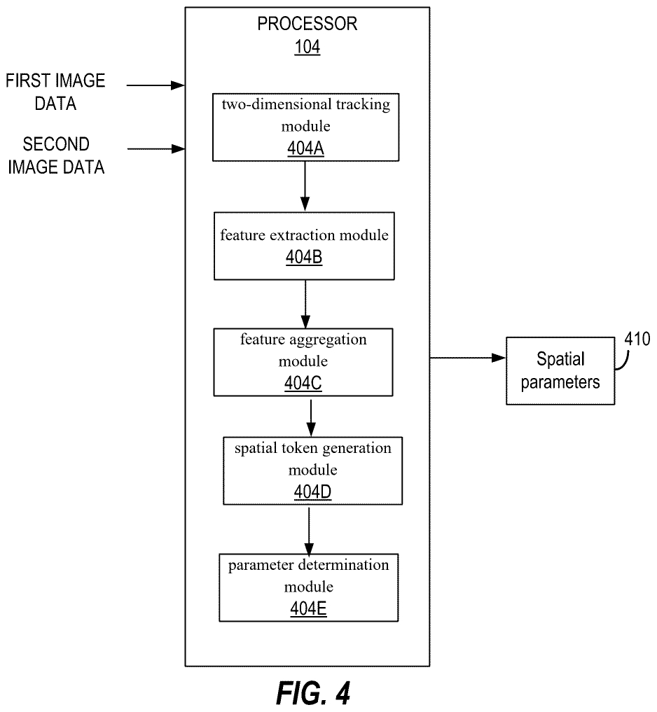

FIG. 4 is a block diagram illustrating an example processor configuration for image data processing in an image capture device according to one or more embodiments of the disclosure. The processor 104, or other processing circuitry, can be configured to operate on image data to perform one or more operations of the method of FIG. 3. Multiple processing cores 104A-N can work in concert to process parallel data streams from different camera views, while the AI engine 124 can provide specialized processing capabilities for feature analysis and object association. The image data can undergo various transformation stages before the system determines three-dimensional (3D) spatial parameters 410 for tracked objects.

The processor 104 can be configured to receive image data from multiple surround-view cameras. This initial input stage can involve coordination between several hardware components. Image data may flow directly from image sensors through dedicated hardware interfaces, or from memory 106 coupled to the sensors for buffered processing. In some implementations, the ISP 112 can perform preliminary image processing before passing data to the main processing pipeline. For distributed processing scenarios, image data may be retrieved from long-term storage through one or more of the WAN adaptor 152, LAN adaptor 153, or PAN adaptor 154.

Block 404A is a two-dimensional tracking module that can be configured to perform object tracking across one or more camera views. The processing block 404A can leverage multiple hardware accelerators within the ISP 112 to track objects across successive frames from each camera view. Direct memory access (DMA) controllers can enable efficient data movement between processing stages while dedicated tracking hardware can maintain real-time performance even with varying object movements and viewing conditions. The module can include configurable processing pipelines that adapt to different camera characteristics and environmental conditions—each with specialized circuits for maintaining object identity across frames.

Block 404B is a feature extraction module that can be configured to extract image features from object data associated with the 2D tracking in each camera view. Multiple processing elements can operate in parallel to identify and isolate relevant features from tracked regions. The implementation can maintain spatial relationships through data structures and memory management schemes. Different processing paths can execute simultaneously across multiple cores with the AI engine 124 executing feature extraction decisions. Advanced caching mechanisms can ensure rapid access to frequently used feature data, while hardware-assisted normalization maintains consistent feature representations.

Block 404C is a feature aggregation module that can be configured to combine extracted image features for objects visible across multiple camera views. This module can implement parallel processing pipelines that stack features while preserving spatial relationships. The hardware architecture can support both single-view and multi-view processing paths with dedicated circuits for generating camera-agnostic representations. Specialized memory controllers can manage feature fusion operations while hardware synchronization mechanisms ensure coherent aggregation across different camera streams. For objects visible in only one view, the block 404B can implement streamlined processing paths that bypass unnecessary fusion operations while maintaining consistent feature representation formats.

Block 404D is a spatial token generation module that can be configured to combine object data with reference vectors to create spatial representation tokens. The block 404D can leverage multiple attention processing units operating in parallel to handle self-attention operations efficiently. Dedicated memory structures can maintain learnable embeddings that adapt to different object characteristics, while arithmetic units accelerate vector operations. The implementation can include hardware-assisted update mechanisms for reference vectors with power management schemes that activate additional processing resources for complex scenes. Through configurable processing paths, the block 404D can encode both spatial and appearance information via cross-attention operations with aggregated features.

Block 404E is a parameter determination module that can be configured to transform combined features and spatial tokens into three-dimensional spatial parameters. Multiple hardware elements can work together in this final processing stage—configured arithmetic units can accelerate cross-attention operations—while temporal consistency circuits maintain stable parameter estimates across frames. The block 404E can generate both position and dimension parameters through parallel processing pipelines. Caching schemes and circular buffers enable efficient temporal consistency checks, where hardware monitoring circuits are continuously assessing processing load. Further, arbitration mechanisms can manage access to shared resources while maintaining processing paths.

In some implementations additional hardware modules can maintain system-wide coordination and optimization. Examples include dedicated DMA engines for high-speed data movement, hardware synchronization mechanisms for maintaining coherence, and specialized circuits for thermal management during sustained operation. The architecture can incorporate configurable clock domains that allow granular power management based on processing requirements. Memory management units can efficiently handle data flow between processing stages while minimizing redundant transfers.

In view of the foregoing, the complete processing pipeline can adapt to varying deployment scenarios through a flexible hardware foundation. Quality-of-service controls can ensure consistent performance across different camera configurations and viewing conditions. Multiple feedback paths between processing blocks enable dynamic adjustment of processing parameters, while sophisticated power management schemes balance performance requirements with energy efficiency. Through this integrated architecture, the system can maintain robust tracking performance without requiring traditional geometric transformation approaches or intermediate BEV computation stages.

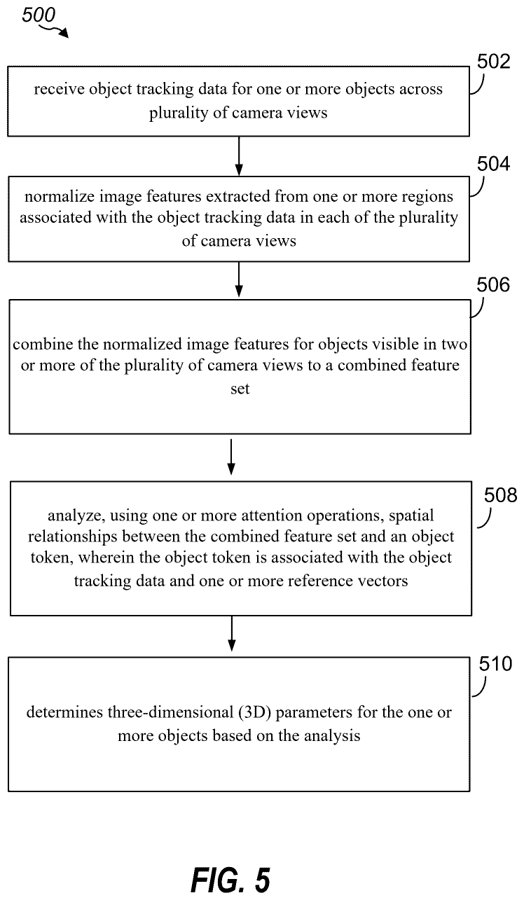

FIG. 5 shows a flow chart of an example method 500 for processing image data to perform three-dimensional (3D) object tracking based on normalized image features according to some embodiments of the disclosure. Through process 500, the system determines 3D parameters by analyzing spatial relationships between combined feature sets and object tokens. Different components of the system, including the processor 104 (with cores 104A-N or AI engine 124) and the ISP 112, may perform various operations described in FIG. 5. The system 200 of FIG. 2 provides the framework for implementing these processing steps.

At block 502, the system receives object tracking data for one or more objects across plurality of camera views. Multiple surround-view cameras, including the first camera 103, may provide this tracking data. Alternatively, the data might be retrieved from memory 106 for processing. A camera application running on processor 104 often can coordinate with camera control 210 to perform data collection from various camera sources. This coordination can ensure proper synchronization of tracking data across different viewpoints.

At block 504, the system normalizes image features extracted from one or more regions associated with the object tracking data in each of the plurality of camera views. The ISP 112 can be configured to transform these features into a standardized format, establishing uniformity across varying object sizes and viewing conditions. Implementation flexibility allows for different normalization approaches depending on scene complexity and processing requirements.

At block 506, the system combines the normalized image features for objects visible in two or more of the plurality of camera views to a combined feature set. Through sophisticated fusion algorithms, these features can merge into unified representations that preserve spatial relationships. The processor 104 can perform this combination process while the ISP 112 can handle real-time feature processing streams.

At block 508, the system analyzes, using one or more attention operations, spatial relationships between the combined feature set and an object token, wherein the object token is associated with the object tracking data and one or more reference vectors. Within the processing pipeline, this analysis can recognize complex spatial patterns and dependencies. Reference vectors associated with the object token can guide the attention mechanisms, enabling precise relationship mapping across feature spaces.

At block 510, the system determines three-dimensional (3D) parameters for the one or more objects based on the analysis. Different algorithms can be utilized to process multiple data streams simultaneously, thereby generating position and orientation estimates while maintaining temporal consistency. The framework can continuously update reference vectors and refine spatial relationships, adapting to changing scene dynamics.

Complex tracking scenarios can trigger additional processing paths following feature combination. During such instances, the system can be configured to transform extracted image features to a standardized format. Multi-view objects can benefit from enhanced fusion techniques that maximize information utilization across viewpoints. The processing pipeline can dynamically adjust strategies based on object visibility patterns and scene complexity.

When handling multiple camera views the system can be configured to generate a unified representation for objects visible in two or more camera views. Here, implementation variations emerge with different mechanism combinations activating depending on scene characteristics. The architecture supports flexible deployment of these unified representations while maintaining processing efficiency across varying conditions.

During process 500, the system can be configured to identify correlations between spatial information in the combined feature set and the object token. After initial parameter determination, continuous refinement processes can engage to monitor these correlations. Advanced filtering techniques help maintain stable tracking even during rapid object movements or partial occlusions, with correlation strength informing tracking confidence. For particularly challenging scenarios, the system can be configured to initialize and update reference vectors based on the object tracking data. Additional processing modules may activate to analyze overlapping view regions in detail. The results enable robust tracking during complex view transitions and occlusion events, with reference vectors adapting to changing conditions.

Throughout all processing stages of process 500, the system can be configured to maintain consistency of the determined 3D parameters across successive frames. This adaptive framework responds to changing environmental conditions and varying camera configurations by adjusting internal processing parameters. Such flexibility enables consistent tracking performance across diverse deployment scenarios without requiring complex geometric transformations or intermediate processing steps.

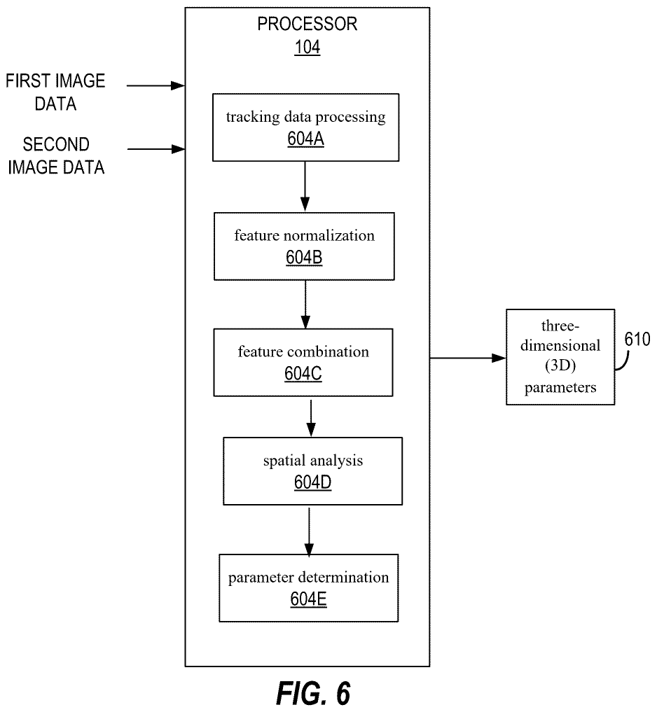

FIG. 6 is a block diagram illustrating an example processor configuration for image data processing in an image capture device according to one or more embodiments of the disclosure. The processor 104, or other processing circuitry, can be configured to operate on image data to perform one or more operations of the method of FIG. 5. Multiple processing cores 104A-N can handle parallel processing streams for feature normalization and analysis, while the AI engine 124 can provide specialized capabilities for attention operations and spatial relationship analysis. The processing architecture enables direct determination of three-dimensional (3D) parameters 610 through analysis of normalized features and object tokens.

The processor 104 can be configured to receive object tracking data from multiple camera sources. This initial stage coordinates data flow through various hardware interfaces tracking data may arrive directly from image sensors, from memory 106, or through network interfaces including the WAN adaptor 152, LAN adaptor 153, or PAN adaptor 154. The ISP 112 can provide preliminary processing support, while dedicated synchronization hardware maintains temporal alignment across multiple data streams.

Block 604A is a tracking data processing module that can be configured to receive object tracking data for one or more objects across multiple camera views. The block 604A can leverage dedicated hardware interfaces for managing multiple data streams from surround-view cameras. The implementation can include specialized synchronization circuits for temporal alignment and configurable DMA controllers enable efficient data movement between input buffers and processing stages. Memory management units can coordinate data flow from various sources, including direct sensor inputs and stored tracking data, with hardware-assisted quality monitoring ensuring data integrity across all input channels.

Block 604B is a feature normalization module that can be configured to normalize image features extracted from regions associated with the object tracking data in each camera view. Multiple processing elements operating in parallel can transform features into standardized formats suitable for subsequent analysis. The hardware architecture can include dedicated normalization accelerators that adapt to varying object sizes and viewing conditions. Caching mechanisms can maintain rapid access to normalization parameters, while hardware-assisted region selection ensures efficient processing of relevant image areas. The module can implement different normalization strategies through configurable processing pipelines that respond to scene complexity and quality requirements.

Block 604C is a feature combination module that can be configured to combine normalized image features for objects visible across multiple camera views into a unified feature set. Block 604C can employ parallel fusion pipelines that preserve spatial relationships while merging features from different views. Dedicated hardware can support sophisticated feature alignment operations with memory controllers managing the combination of features from multiple sources. The implementation can include hardware-assisted validation mechanisms that ensure feature consistency during combination. Also, configurable processing paths can optimize handling based on feature characteristics and scene conditions.

Block 604D is a spatial analysis module that can be configured to analyze relationships between combined feature sets and object tokens using attention operations. Multiple attention processing units can operate simultaneously to handle complex spatial patterns with dedicated hardware accelerating both self-attention and cross-attention computations. The module can maintain reference vectors through specialized memory structures while arithmetic units optimize attention operation performance. Power management schemes can activate additional processing resources for complex scenes where, e.g., hardware monitoring circuits continuously assess computational requirements.

Block 604E is a parameter determination module that can be configured to generate 3D parameters based on spatial analysis results. In some implementations, the block 604E can involve specialized hardware elements, e.g., dedicated arithmetic units can accelerate parameter computation, while dedicated circuits maintain temporal consistency across frames. Arbitration mechanisms can manage access to shared resources and hardware-assisted validation can ensure parameter accuracy. The module can adapt processing paths based on scene complexity and quality requirements and configurable feedback loops can be enabled for incremental parameter refinement.

The foregoing architecture can incorporate additional hardware modules for system-wide coordination. For example, dedicated DMA engines can manage high-speed data transfers between processing blocks, while hardware synchronization mechanisms maintain processing coherence. Monitoring circuits can track thermal conditions and processing loads, enabling dynamic resource allocation based on workload requirements. Also, the implementation can include configurable clock domains for each processing block to enable granular power management during operation. With regard to memory management, multiple cache levels and buffers can support data sharing between processing stages. The architecture can implement quality-of-service controls to maintain processing priorities, while advanced arbitration schemes manage access to shared resources. Finally, validation mechanisms can monitor data integrity throughout the processing pipeline.

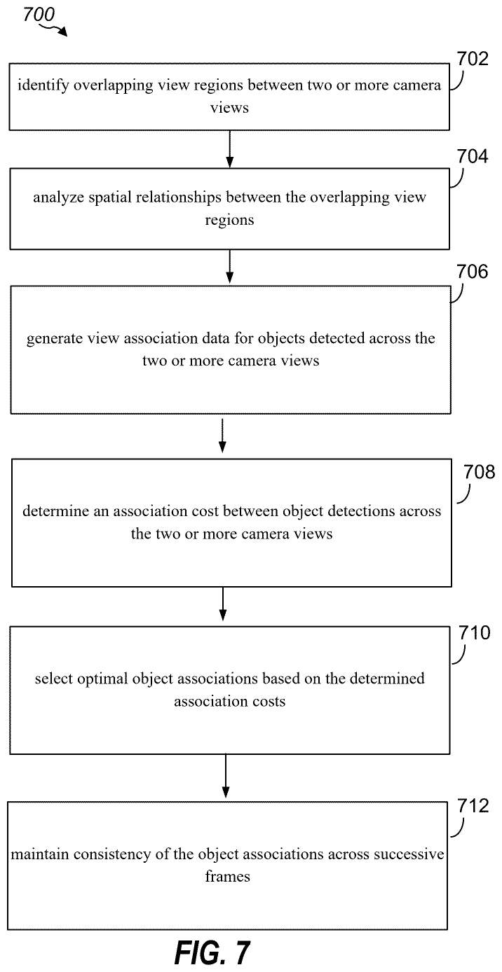

FIG. 7 shows a flow chart of an example method 700 for processing image data to perform cross-view object association according to some embodiments of the disclosure. Through this processing, the system manages object tracking and association across multiple camera views while maintaining temporal consistency. Different components of the system, including the processor 104 (with cores 104A-N or AI engine 124), the ISP 112, and various camera interfaces can perform the operations described in FIG. 7. Memory 106 may store intermediate processing results and association data, while network interfaces including the WAN adaptor 152 and LAN adaptor 153 can facilitate distributed processing across multiple processing nodes when needed.

At block 702, the system identifies overlapping view regions between two or more camera views. The camera control 210 coordinates with multiple image sensors to determine geometric relationships between their fields of view. Complex calibration processes may run during system initialization to establish baseline overlap parameters, with the ISP 112 processing raw sensor data to determine precise view intersection boundaries. The system can continuously update these overlap regions as camera positions or viewing angles change during operation.

At block 704, the system analyzes spatial relationships between the overlapping view regions. Through geometric processing pipelines implemented across multiple cores 104A-N, the system can establish mappings between different camera perspectives. The AI engine 124 may contribute advanced feature analysis capabilities, particularly when dealing with complex scenes containing multiple moving objects. This spatial analysis forms a foundation for subsequent association steps with results stored in memory 106 for rapid access during real-time processing.

At block 706, the system generates view association data for objects detected across the two or more camera views. This generation process can involve multiple processing streams managed by the ISP 112 and processor 104. The system can create comprehensive object representations by combining information from different viewpoints top adapt to varying environmental conditions and scene complexity. Advanced feature extraction techniques operating across multiple cores can identify distinctive object characteristics that aid in reliable association.

At block 708, the system determines an association cost between object detections across the two or more camera views. The processor 104 can perform this computation while considering multiple geometric and appearance factors. Association costs can reflect both spatial relationships and temporal consistency requirements—with the AI engine 124 potentially contributing learned cost metrics based on historical tracking data. Implementation variations emerge based on scene characteristics and processing requirements where different cost computation strategies are activated as needed.

At block 710, the system selects optimal object associations based on the determined association costs. Through, e.g., optimization techniques distributed across available processing cores, the framework evaluates potential association combinations to identify optimal matches. Environmental factors, lighting variations, and object characteristics influence the selection process. Here, the ISP 112 can provide real-time updates to cost metrics based on changing scene conditions to enable dynamic adjustment of association decisions.

At block 712, the system maintains consistency of the object associations across successive frames. Doing so involves continuous monitoring and adjustment processes spanning multiple processing components. The system can update association parameters based on new tracking data while preserving stable object identities during view transitions. When particularly challenging scenarios arise additional processing modules may activate to analyze overlapping view regions in detail and compute sophisticated relationship metrics.

Throughout the processing steps of process 700, the system can employ various optimization techniques to maintain robust performance. These include transformer-based attention mechanisms for information sharing between views, learned detection and tracking representations, and adaptive confidence estimation. The framework can adjust processing parameters dynamically based on implementation requirements and camera configurations, ensuring reliable tracking even when objects become temporarily occluded or move between views. Memory 106 can maintain historical tracking data that informs these optimizations, while the distributed processing architecture enables efficient handling of complex scenes.

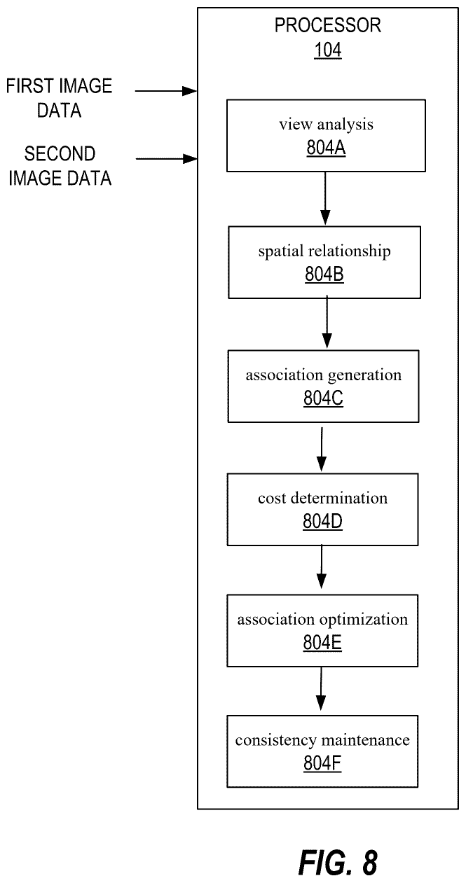

FIG. 8 is a block diagram illustrating an example processor configuration for cross-view object association according to one or more embodiments of the disclosure. The processor 104, or other processing circuitry, can be configured to operate on image data to perform one or more operations of the method of FIG. 7. Multiple processing cores 104A-N can handle parallel processing streams for view analysis and object association, while the AI engine 124 can provide specialized capabilities for spatial relationship analysis and association optimization. Memory 106 can store intermediate processing results while network interfaces enable distributed processing across multiple nodes.

The processor 104 can be configured to receive image data from multiple surround-view cameras for view region analysis. Processing steps may occur through various hardware interfaces, e.g., camera data may be received through direct sensor connections or through memory 106. The ISP 112 can provide preliminary image processing support, while dedicated hardware maintains synchronization across camera streams. Arbitration mechanisms can manage data flow from multiple sources while maintaining temporal alignment.

Block 804A is a view analysis module that can be configured to identify overlapping regions between multiple camera views. Block 804A can employ dedicated hardware for geometric analysis of camera fields of view. Multiple calibration circuits can establish and maintain baseline overlap parameters and dedicated DMA controllers enable efficient data movement across blocks. The implementation can include configurable processing pipelines that adapt to changing camera positions and viewing angles.

Block 804B is a spatial relationship module that can be configured to analyze spatial relationships between identified overlapping regions. Geometric processing units can operate to establish precise mappings between different camera perspectives. The architecture can include dedicated circuits for complex scene analysis, with the AI engine 124 contributing specialized processing capabilities. Efficient memory management enables access to spatial relationship data during real-time processing.

Block 804C is an association generation module that can be configured to generate view association data for objects detected across multiple camera views. Block 804C can leverage parallel pipelines for creating comprehensive object representations. Also, dedicated hardware accelerators can support feature extraction across multiple cores. The implementation can include configurable processing paths that adapt to environmental conditions and scene complexity.

Block 804D is a cost determination module that can be configured to compute association costs between object detections across camera views. Here, multiple processing elements can evaluate geometric and appearance factors simultaneously, while dedicated hardware supports learned cost metric computation. The module can implement different cost computation strategies through configurable processing paths with specialized circuits monitoring temporal consistency requirements.

Block 804E is an association optimization module that can be configured to select optimal object associations based on computed costs. In an implementation, optimization circuits can evaluate multiple association combinations in parallel while dedicated hardware supports real-time cost metric updates. The implementation can include arbitration mechanisms for managing computational resources across different optimization strategies.

Block 804F is a consistency maintenance module that can be configured to maintain temporal consistency of object associations across frames. The module can implement additional processing paths for analyzing challenging scenarios with configurable resources for relationship metric computation.

Supporting hardware modules enable efficient system-wide operation. For example, dedicated DMA engines can manage data movement between processing blocks and specialized synchronization circuits can maintain processing coherence. The architecture implements configurable clock domains for power management, with hardware monitors tracking thermal conditions and processing loads. Also, the processing pipeline utilizes memory management and resource allocation mechanisms where, e.g., multiple cache levels support efficient data sharing, while quality-of-service controls maintain processing priorities. Further, arbitration schemes manage access to shared resources with hardware validation mechanisms ensuring data integrity throughout the processing pipeline.

In one or more aspects, techniques for supporting image processing may include additional aspects, such as any single aspect or any combination of aspects described below or in connection with one or more other processes or devices described elsewhere herein. In a first aspect, supporting image processing may include an apparatus configured to perform two-dimensional (2D) tracking of one or more objects across one or more camera views and extract one or more image features from object data associated with the 2D tracking in each of the one or more camera views. The apparatus is further configured to aggregate the extracted image features for one or more objects visible in two or more of the one or more camera views, generate a spatial representation token based on the object data and one or more reference vectors, and determine three-dimensional (3D) spatial parameters for the one or more objects based on the aggregated features and the spatial representation token.

Additionally, the apparatus may perform or operate according to one or more aspects as described below. In some implementations, the apparatus includes an image processing device. In some implementations, the apparatus includes a remote server, such as a cloud-based computing solution, which receives image data for processing to determine output image frames. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein.

In a second aspect, in combination with the first aspect, the apparatus is further configured to extract features from regions of the one or more camera views corresponding to the object data and normalize the extracted features.

In a third aspect, in combination with one or more of the first aspect or the second aspect, the apparatus is further configured to stack the extracted image features for objects visible in the two or more camera views and generate camera-agnostic features from the extracted image features.

In a fourth aspect, in combination with one or more of the first aspect through the third aspect, the apparatus is further configured to perform one or more cross-attention operations between the aggregated features and the spatial representation token when determining the 3D spatial parameters.

In a fifth aspect, in combination with one or more of the first aspect through the fourth aspect, the apparatus is further configured to initialize a set of reference vectors, update the reference vectors using self-attention operations, and combine the updated reference vectors with spatial information from the object data.

In a sixth aspect, in combination with one or more of the first aspect through the fifth aspect, the apparatus is further configured to differentiate the extracted image features for objects visible in only one of the one or more camera views compared to objects visible in two or more of the one or more camera views.

In a seventh aspect, in combination with one or more of the first aspect through the sixth aspect, the apparatus is further configured to generate at least one of a position parameter or a dimension parameter for each of the one or more objects and maintain consistency of the generated parameters across successive frames.

In an eighth aspect, in combination with one or more of the first aspect through the seventh aspect, the one or more reference vectors are learnable embeddings initialized prior to generating the spatial representation token.

In a ninth aspect, in combination with one or more of the first aspect through the eighth aspect, the spatial representation token encodes at least one of spatial information or appearance information from the object data through a cross-attention operation with the aggregated features.

In a tenth aspect, an apparatus is configured to receive object tracking data for one or more objects across one or more camera views, normalize image features extracted from one or more regions associated with the object tracking data in each of the one or more camera views, combine the normalized image features for objects visible in two or more of the one or more camera views to a combined feature set, analyze spatial relationships between the combined feature set and an object token using attention operations, wherein the object token is associated with the object tracking data and one or more reference vectors, and determine 3D parameters for the one or more objects based on the analysis.

In an eleventh aspect, in combination with the tenth aspect, the apparatus is further configured to transform the extracted image features to a standardized format.

In a twelfth aspect, in combination with one or more of the tenth aspect through the eleventh aspect, the apparatus is further configured to generate a unified representation for objects visible in the two or more camera views.

In a thirteenth aspect, in combination with one or more of the tenth aspect through the twelfth aspect, the apparatus is further configured to identify one or more correlations between spatial information in the combined feature set and the object token.

In a fourteenth aspect, in combination with one or more of the tenth aspect through the thirteenth aspect, the apparatus is further configured to initialize the one or more reference vectors and update the reference vectors based on the object tracking data.

In a fifteenth aspect, in combination with one or more of the tenth aspect through the fourteenth aspect, the apparatus is further configured to maintain consistency of the determined 3D parameters across successive frames.

In a sixteenth aspect, an apparatus is configured to identify overlapping view regions between two or more camera views, analyze spatial relationships between the overlapping view regions, generate view association data for objects detected across the two or more camera views, determine an association cost between object detections across the two or more camera views, select optimal object associations based on the determined association costs, and maintain consistency of the object associations across successive frames.

In a seventeenth aspect, in combination with the sixteenth aspect, the apparatus is further configured to determine optimal matching between object detections based on Hungarian matching techniques.

In an eighteenth aspect, in combination with one or more of the sixteenth aspect through the seventeenth aspect, the apparatus is further configured to generate information sharing operations between the overlapping view regions, wherein the operations include transformer-based attention mechanisms.

In a nineteenth aspect, in combination with one or more of the sixteenth aspect through the eighteenth aspect, the apparatus is further configured to generate object representations that include learned detection and tracking information across the two or more camera views.

In a twentieth aspect, in combination with one or more of the sixteenth aspect through the nineteenth aspect, the apparatus is further configured to generate object region indicators for the two or more camera views and compute correspondence metrics between detected objects and reference objects in corresponding views.

In a twenty-first aspect, in combination with one or more of the sixteenth aspect through the twentieth aspect, the apparatus is further configured to account for regions where objects are not visible and adjust confidence indicators for such regions.

In a twenty-second aspect, an apparatus including means for performing operations according to any combination of the first aspect through the twenty-first aspect.

In a twenty-third aspect, a non-transitory computer-readable medium including executable instructions that, when executed by at least one processor of an apparatus, cause the apparatus to perform operations according to any combination of the first aspect through the twenty-first aspect.

In a twenty-fourth aspect, a computer program product embodied on a computer-readable storage medium including code for performing operations according to any combination of the first aspect through the twenty-first aspect.

In a twenty-fifth aspect, an image processing device comprising: one or more image sensors; one or more processors; and one or more memories comprising instructions executable by the one or more processors to perform operations according to any combination of the first aspect through the twenty-first aspect.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Aspects of the present disclosure are applicable to any electronic device including, coupled to, or otherwise processing data from one, two, or more image sensors capable of capturing image frames (or “frames”). The terms “output image frame,” “modified image frame,” and “corrected image frame” may refer to an image frame that has been processed by any of the disclosed techniques to adjust raw image data received from an image sensor. Further, aspects of the disclosed techniques may be implemented for processing image data received from image sensors of the same or different capabilities and characteristics (such as resolution, shutter speed, or sensor type). Further, aspects of the disclosed techniques may be implemented in devices for processing image data, whether or not the device includes or is coupled to image sensors. For example, the disclosed techniques may include operations performed by processing devices in a cloud computing system that retrieve image data for processing that was previously recorded by a separate device having image sensors.

Unless specifically stated otherwise as apparent from the following discussions, it is appreciated that throughout the present application, discussions using terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating,” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices. The use of different terms referring to actions or processes of a computer system does not necessarily indicate different operations. For example, “determining” data may refer to “generating” data. As another example, “determining” data may refer to “retrieving” data.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (e.g., application specific integrated circuits (ASICs), digital signal processors (DSP), graphics processing unit (GPU), central processing unit (CPU), computer vision processor (CVP), or neural signal processor (NSP)) configured to perform the recited function through hardware, software, or a combination of hardware configured by software.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to the Figures referenced above include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art will understand that one or more blocks (or operations) described with reference to FIGS. 3 and 4 may be combined with one or more blocks (or operations) described with reference to another of the figures. For example, one or more blocks (or operations) of FIG. 3 may be combined with one or more blocks (or operations) of FIGS. 1-2. As another example, one or more blocks associated with FIG. 4 may be combined with one or more blocks (or operations) associated with FIGS. 1-2.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. An apparatus, comprising:
a memory storing processor-readable code; and
at least one processor coupled to the memory, the at least one processor configured to execute the processor-readable code to cause the at least one processor to perform operations including:
performing two-dimensional (2D) tracking of one or more objects across a plurality of camera views;
extracting one or more image features from object data associated with the 2D tracking in each of the plurality of camera views;
aggregating the extracted image features for one or more objects visible in two or more of the plurality of camera views;
generating a spatial representation token based on the object data and one or more reference vectors; and
determining three-dimensional (3D) spatial parameters for the one or more objects based on the aggregated features and the spatial representation token.

2. The apparatus of claim 1, wherein extracting the one or more image features comprises:
extracting features from regions of the plurality of camera views corresponding to the object data; and
normalizing the extracted features.

3. The apparatus of claim 1, wherein aggregating the extracted image features comprises:
stacking the extracted image features for objects visible in the two or more camera views; and
generating camera-agnostic features from the extracted image features.

4. The apparatus of claim 1, wherein determining the 3D spatial parameters comprises:
performing one or more cross-attention operations between the aggregated features and the spatial representation token.

5. The apparatus of claim 1, wherein generating the spatial representation token comprises:
initializing a set of reference vectors;
updating the reference vectors using self-attention operations; and
combining the updated reference vectors with spatial information from the object data.

6. The apparatus of claim 1, wherein aggregating the extracted image features comprises:
differencing the extracted image features for objects visible in only one of the plurality of camera views compared to objects visible in two or more of the plurality of camera views.

7. The apparatus of claim 1, wherein determining the 3D spatial parameters comprises:
generating at least one of a position parameter or a dimension parameter for each of the one or more objects; and
maintaining consistency of the generated parameters across successive frames.

8. The apparatus of claim 1, wherein the one or more reference vectors are learnable embeddings initialized prior to generating the spatial representation token.

9. The apparatus of claim 1, wherein the spatial representation token encodes at least one of spatial information or appearance information from the object data through a cross-attention operation with the aggregated features.

10. An apparatus, comprising:
a memory storing processor-readable code; and
at least one processor coupled to the memory, the at least one processor configured to execute the processor-readable code to cause the at least one processor to perform operations including:
receiving object tracking data for one or more objects across plurality of camera views;
normalizing image features extracted from one or more regions associated with the object tracking data in each of the plurality of camera views;
combining the normalized image features for objects visible in two or more of the plurality of camera views to a combined feature set;
analyzing, using one or more attention operations, spatial relationships between the combined feature set and an object token, wherein the object token is associated with the object tracking data and one or more reference vectors; and
determining three-dimensional (3D) parameters for the one or more objects based on the analysis.

11. The apparatus of claim 10, wherein normalizing the image features comprises:
transforming the extracted image features to a standardized format.

12. The apparatus of claim 10, wherein combining the normalized image features comprises:
generating a unified representation for objects visible in the two or more camera views.

13. The apparatus of claim 10, wherein analyzing the spatial relationships comprises:
identifying one or more correlations between spatial information in the combined feature set and the object token.

14. The apparatus of claim 10, wherein the object token is generated by:
initializing the one or more reference vectors; and
updating the reference vectors based on the object tracking data.

15. The apparatus of claim 10, wherein determining the 3D parameters comprises: maintaining consistency of the determined 3D parameters across successive frames.

16. An apparatus, comprising:
a memory storing processor-readable code; and
at least one processor coupled to the memory, the at least one processor configured to execute the processor-readable code to cause the at least one processor to perform operations including:
identifying overlapping view regions between two or more camera views;
analyzing spatial relationships between the overlapping view regions;
generating view association data for objects detected across the two or more camera views;
determining an association cost between object detections across the two or more camera views;
selecting object associations based on the determined association costs; and
maintaining consistency of the object associations across successive frames.

17. The apparatus of claim 16, wherein selecting the optimal object associations comprises:
determining optimal matching between object detections based on Hungarian matching techniques.

18. The apparatus of claim 16, wherein analyzing the spatial relationships comprises:
generating information sharing operations between the overlapping view regions, wherein the operations include transformer-based attention mechanisms.

19. The apparatus of claim 16, wherein generating the view association data comprises:
generating object representations that include learned detection and tracking information across the two or more camera views.

20. The apparatus of claim 16, wherein determining the association costs comprises:
generating object region indicators for the two or more camera views; and
computing correspondence metrics between detected objects and reference objects in corresponding views.

21. The apparatus of claim 20, wherein computing the correspondence metrics comprises:
accounting for regions where objects are not visible; and
adjusting confidence indicators for such regions.
